(19) United States
(12) Patent Application Publication
(10) Pub. No.: US 2018/0160025 A1
(43) Pub. Date: Jun. 7, 2018

(54) AUTOMATIC CAMERA CONTROL SYSTEM FOR TENNIS AND SPORTS WITH MULTIPLE AREAS OF INTEREST

(71) Applicant: FLETCHER GROUP, LLC, Burr Ridge, IL (US)

(72) Inventors: Dwayne K. PALLANTI, Tinley Park, IL (US); Daniel J. GRAINGE, Elmhurst, IL (US)

(21) Appl. No.: 15/811,397

(22) Filed: Nov. 13, 2017

Related U.S. Application Data
(60) Provisional application No. 62/430,208, filed on Dec. 5, 2016.

(51) Int. Cl. H04N 5/232; G01S 17/89; H04N 5/247

(52) U.S. Cl. CPC H04N 5/23203; H04N 5/247; G01S 17/89; H04N 5/23216

(57) ABSTRACT

A single operator, automatic camera control system is disclosed for providing action images of players, during a sporting event. A LiDAR scanner obtains images from a field of play and is configured for generating multiple sequential LiDAR data of each player on the field. At least one fixed video camera is focused on a designated area of the field for generating video images that supplement the LiDAR data. A control computer is connected to the LiDAR scanner and the at least one video camera and is configured to combine the LiDAR data and the video images to create a composite target image representative of each player, and to update the composite target image during the sporting event.

### RELATED APPLICATION

This application claims 35 USC 119 Priority from U.S. Ser. No. 62/430,208 filed Dec. 5, 2016.

### BACKGROUND

The present invention relates generally for automatic camera systems, and more specifically to an automatic camera control system for following and recording the movement of players in a sporting event, such as a tennis match or the like.

Conventional sports photography systems feature at least one manually controlled camera. Preferably, a plurality of cameras is provided, each camera controlled by a separate operator and being disposed in various locations around the field of play to provide multiple vantage points. Often the cameras are identified by numbers. A program director selects the appropriate camera to broadcast, depending on the status of the action of the particular sporting event. However, a drawback of conventional multiple operator systems is the number of operators required, and often a certain percentage of the operators are used in a limited basis, depending on the action of the particular event.

In some limited applications, a system is provided using at least one operator-controlled camera, referred to as a Master, and at least one automatically controlled camera called a Slave. To record a particular sporting event, the operator directs the Master camera on target point of action. The connected Slave cameras also focus on the same point, but from different vantage points located around the field of play. Master/Slave systems are configured so that the master camera is connected to the slave cameras through a hardwired network, wirelessly or through the Internet. Thus, the action followed by the main camera is supplemented by the slave cameras which are focused on the same subject, from different angles or perspectives. Such systems have not achieved widespread adoption by broadcasters of sporting events.

In the case of tennis matches, video broadcasts are handled by an operator-controlled camera at, or elevated from each service end of the court, as well as ground-level cameras located near or focused on the net area. Due to the rapid nature of the game, conventional systems require operators at each camera.

Despite the number of cameras and operators, conventional systems have not been able to effectively follow the movement of the players during the game, or to simultaneously broadcast two areas of interest without employing multiple operators. There is an interest in reducing the use of individual camera operators.

### SUMMARY

The above-listed needs are met or exceeded by the present automatic camera control system for tennis and similar sports having multiple areas of interest, which, in a preferred embodiment features the use of data from a rapidly cycling LiDAR scanner and images received from two fixed video cameras which are combined to create an image template used to locate and follow individual players. Data obtained from the LiDAR scanner and images received from the fixed cameras are fed to a main control system, which then controls the movement of up to four broadcast video cameras, automatically following selected players during play. A single operator oversees the control system, as well as multiple broadcast cameras, and has the ability to independently move the broadcast cameras when desired to focus on targets outside the field of play, such as the crowd, surrounding scenery and the like. In the present system, each of the automatically-controlled broadcast cameras provide usable shots for live and replay use.

In operation, initially, the operator enters geographic limits to the LiDAR and fixed video cameras, so that any images seen by the cameras that are located outside the target field of play are filtered out. The LiDAR scanner features multiple individual laser beams, with approximately 12 such beams preferred, which sweep the target area approximately 20 times per second. In addition, the LiDAR scanner is used to generate multiple reflection points from at least one and preferably a plurality of predesignated target images, representing each player. These images are referred to as Pretargets. The number of Pretargets/players may vary to suit the situation. In addition, the fixed video cameras are positioned so that each of the cameras views a designated half of the court. Reflection points from the LiDAR scanner, and images from the video cameras are sent to the main control system, preferably a control computer.

The central control computer has a first module operating the LiDAR scanner that generates composite images from the LiDAR scanner and the video cameras, which then converts the data into a suitable format for transmission to the broadcast cameras. More specifically, during play, the actual composite Pretarget images are compared with the actual Targets generated by the LiDAR and the video cameras. Periodic snapshots of each Target are stored. Due to the real time operation of the LiDAR and the cameras, the control computer is continually examining the images for color, location within the reference geographic zone, and is also converting Target position coordinates to conventional PTZF instructions to be sent to the broadcast cameras. The ultimate images that are transmitted from the broadcast cameras are determined by a Broadcast Director as the game progresses as is known in the art.

While the LiDAR scanner optionally works alone, if the system loses track of a specific player, it is difficult to regain it. Similarly, fixed video cameras optionally work alone using visual tracking, but lack the highly accurate distance information provided by the LiDAR scanner.

In another embodiment, a multi-camera, single operator Master/Slave system is provided, currently of interest for basketball, soccer and other field sports. The Master/Slave system allows a remote camera operator to control the PTZF movement of up to four broadcast video cameras simultaneously at a field-based or court-based sporting event. The cameras are connected to a main control computer and are organized so that the operator controls a Master camera and up to three Slave cameras point to the same place on the field of play. Zoom and focus of each Slave camera is controlled automatically according to parameters selected by the operator before the event begins.

In the present Master/Slave system, the operator focuses each camera on a plurality of Correspondence Points, focuses the lens on each and saves the data in the control computer. This process is repeated for each of the cameras. Then, the operator determines the field of view of each of the cameras, and the control computer calculates homography matrices for the Correspondence Points and for the overall field of play boundaries. If desired, the operator selects designated zoom tracks for each of the cameras, which are saved by the control computer. This will allow a single person to manage the operation of all cameras needed for broadcast coverage of these events, providing usable shots from each camera for live and replay use. Before play begins, the operator selects which camera is the Master, enters that data in the control computer, which checks the homography indices for the Master and coordinates same with the Slave cameras. During play, the control computer runs decision loops that constantly check the position of the Master and the Slave cameras against the preset homography parameters.

Thus, the present Master/Slave system features the ability to limit the range of each camera's motion based on the angle of view relative to the playing field (court). Another feature is automatic zooming of each camera lens based on a current viewpoint.

More specifically, the present invention provides a single operator, automatic camera control system for providing action images of at least one player on a field of play, during a sporting event. The system includes a LiDAR scanner disposed to obtain images from the field of play and constructed and arranged for generating multiple sequential LiDAR data of the at least one player on the field of play. At least one fixed video camera is disposed to focus on a designated area of the field of play for generating video images that supplement the LiDAR images. A control computer is connected to the LiDAR scanner and the at least one video camera and is configured to combine the LiDAR data and the video images to create a composite target image representative of the at least one player, and to update the composite target image during the sporting event.

In another embodiment, a method of obtaining images of at least one player on a playing field during a sporting event is provided, including generating, using a LiDAR scanner, LiDAR data from the at least one player on the field of play, generating, using at least one fixed video camera, reference video images of the at least one player on the field of play corresponding to the LiDAR data, combining the LiDAR data and the video images to create a composite target image representative of the at least one player, updating the composite target image during the sporting event.

In yet another embodiment, a multi-camera, single operator Master/Slave camera system is provided, including a plurality of broadcast cameras, and a control computer connected to each of the cameras. The control computer is constructed and arranged so that geographic field, correspondence points, zoom and focus field data is preset for each camera, one of the cameras is selected as a Master camera, the remaining cameras are designated Slaves. The control computer is configured for calculating homography matrices for the correspondence points and for the overall field of play boundaries. During play, the control computer is configured for running decision loops that repeatedly check the position of the Master and the Slave cameras against the preset homography parameters.

### BRIEF DESCRIPTION OF THE DRAWINGS

FIG. 1 is a schematic view of a tennis court equipped with the present camera control system;

FIG. 2 is an enlarged perspective view of the control and display for the present camera control system of FIG. 1;

FIG. 3 is an enlarged perspective view of the cameras used in the system of FIG. 1;

FIGS. 4A-4E are a decision tree flow chart used in the present Master/Slave camera control system;

FIGS. 5A-5B are a decision tree flow chart of the present LiDAR-based system; and

FIG. 6 is a display of the composite image targets generated for players using the system of FIGS. 5A-5B.

### DETAILED DESCRIPTION

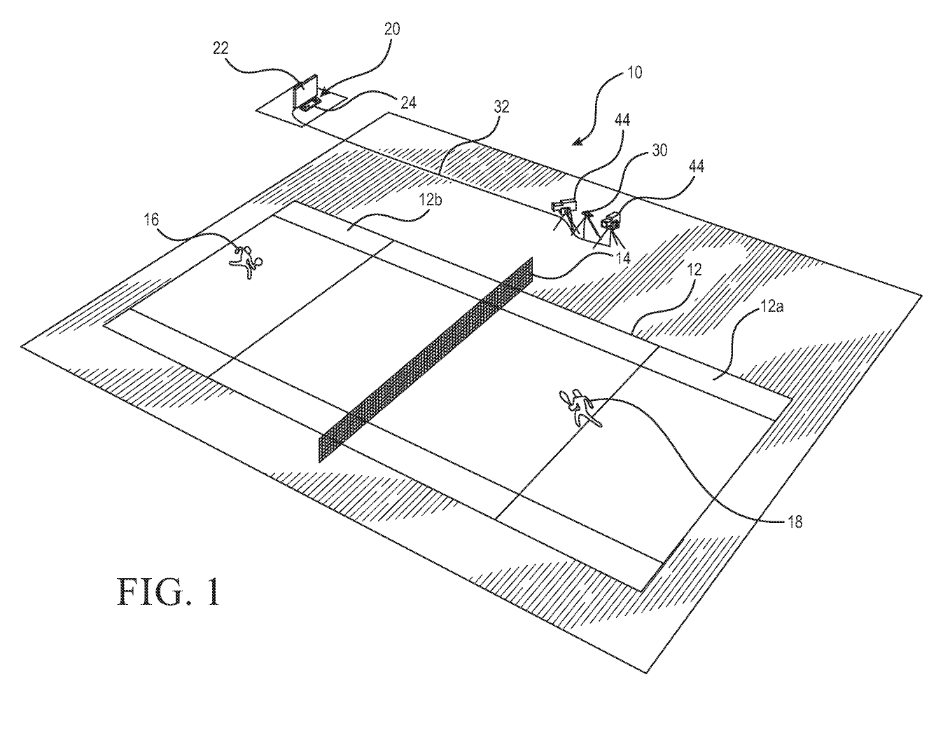

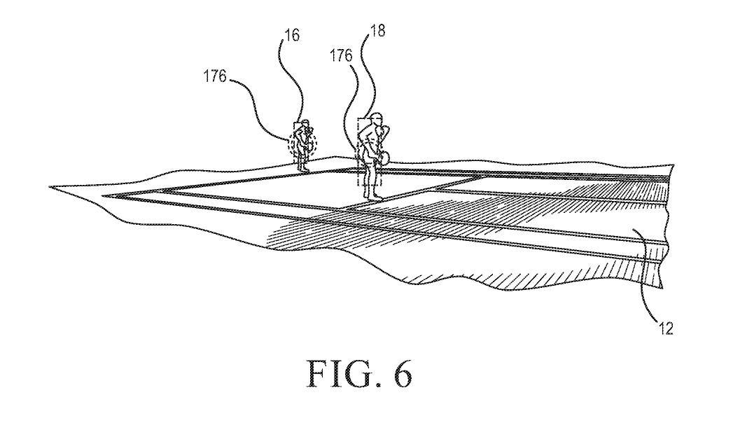

Referring now to FIGS. 1 and 6, the present automatic camera control system is generally designated 10, and is shown disposed to record images from a sporting event field of play 12, depicted as a tennis court. However, other fields of play are contemplated, including but not limited to basketball, hockey, soccer, baseball, football, horse racing and the like. As shown, the field of play 12 has two regions, 12a and 12b, each representing a side of a net 14. At least one, and in this embodiment, preferably two players 16 and 18 are each active in a designated one of the regions 12a, 12b. However, as is known in the game of tennis, the players change regions during the course of the match. A feature of the present system 10 is that ability to record for subsequent broadcast images of the activity of both players using only a single camera operator.

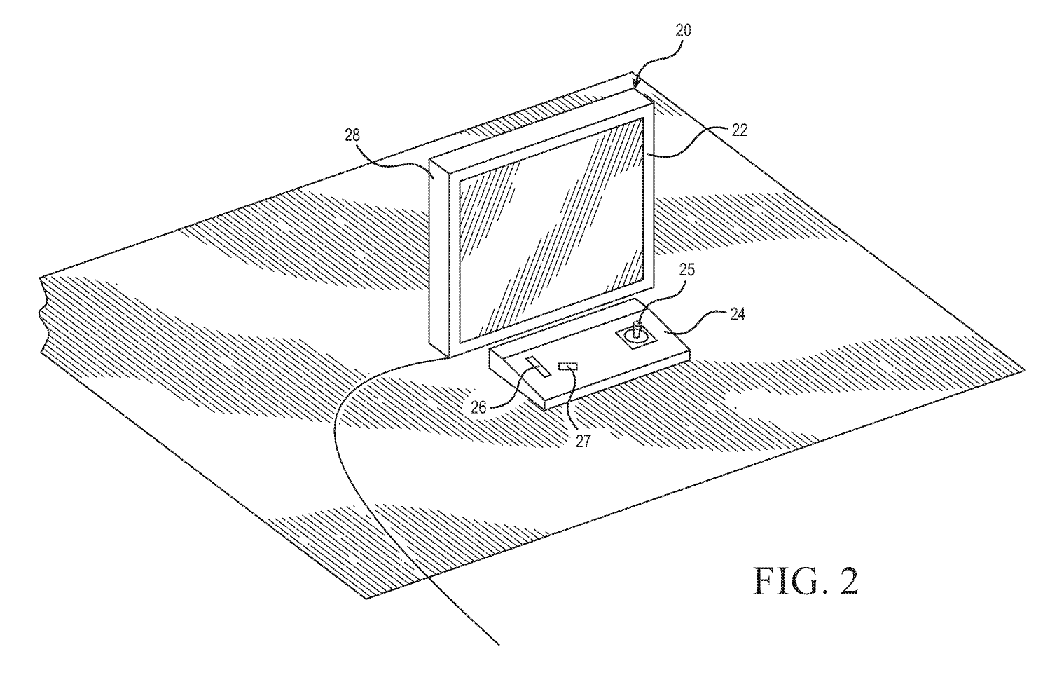

Referring now to FIG. 2, the single operator interacts with the system 10 via a workstation in the form of a control computer 20, preferably having a touch-screen display 22 running a software application that processes 3D point-cloud, video image and control data generated as described below. The control computer 20 provides the main user interface for the system 10 and produces control signals for pan, tilt, zoom and focus to each of the cameras. Included with the computer 20 is a keyboard or input control panel 24, preferably a Pan/Tilt/Zoom/Focus (PTZF) panel including a joystick control 25 (for pan/tilt), a hand wheel 26 (for focus) and single-axis rocker-type joystick 27 (for zoom). This produces data for manual control of any of the cameras. As is known in the art, the computer 20 includes a processor 28, which is presently shown as combined with the display 22. It is contemplated that the specific format and orientation of components of the control computer is not limited to those depicted, and may vary to suit the application.

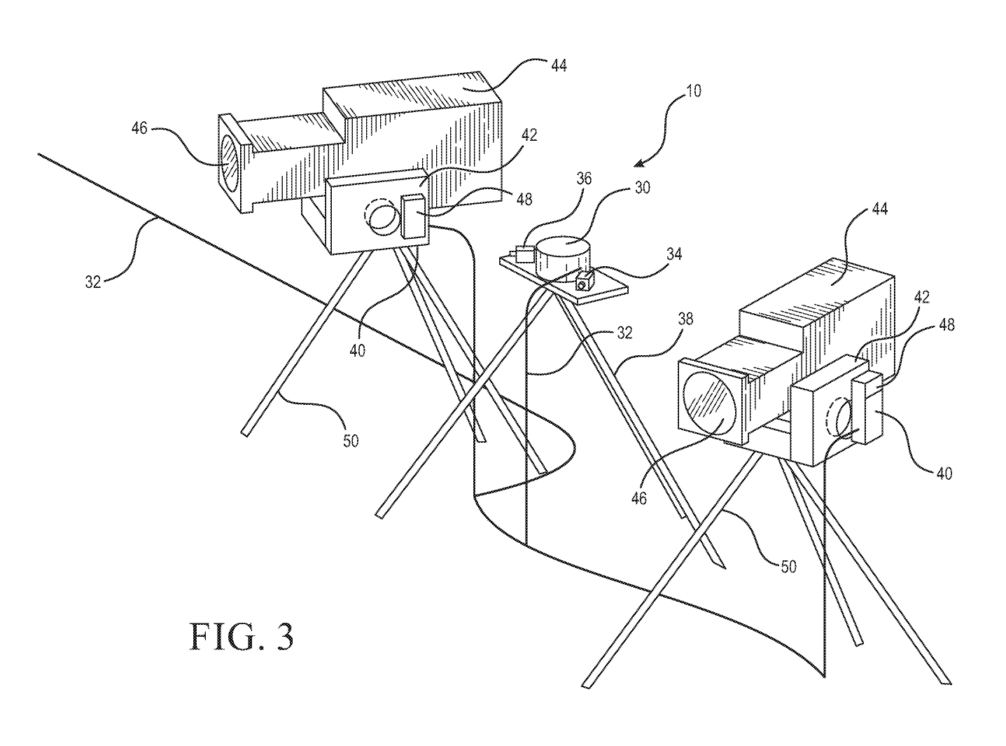

Referring now to FIG. 3, the present system 10 also includes a LiDAR scanner 30 which is connected to the control computer 20, either by cables 32 or wirelessly as is known in the art. A preferred unit is a Velodyne VLP-16 high definition Velodyne LiDAR, Morgan Hill, Calif. More specifically, the LiDAR scanner 30 is a laser-based scanning device including at least 16 laser/detector pairs that rotate up to 20 times per second, analyzing the laser light reflected from people and objects in the surrounding environment. This scanner 30 produces a data stream that includes positional information within a range of 1 to 100 meters. The LiDAR scanner 30 is disposed relative to the field of play 12 to obtain images from the field of play and is constructed and arranged for generating multiple sequential LiDAR data of the at least one player on the field of play. The LiDAR data, is used to produce a 3D point cloud in real time.

Also included is at least one, and preferably two fixed video cameras 34 and 36, each focused on a respective region 12a, 12b of the field of play 12. In the preferred embodiment, the cameras 34, 36, which are connected to the control computer 20 by cables 32 or wirelessly, are HD video cameras aligned with the field-of-view of the LiDAR scanner 30 to produce video image data of the environment surrounding the players 16, 18. The fixed video cameras 34, 36 are disposed to focus on a designated area of the field of play for generating video images that supplement the LiDAR data, particularly regarding the location of the players 16, 18. As shown, the LiDAR scanner 30 and the fixed video cameras 34, 36 are mounted on a mobile support 38, preferably a tripod.

As described in more detail below, the control computer 20 is connected to the LiDAR scanner 30 and the fixed video cameras 34, 36 and is configured to combine the LiDAR data and the video images to create a composite target image representative of the players 16, 18, referred to as a PreTarget to differentiate the image from other target images received by the scanner, referred to as Targets, and to update the composite target image during the sporting event.

In addition, the system 10 includes at least one digital interface 40, which is a microcomputer-based device that (1): receives the digital control signals from the control computer 20 and converts them to analog control signals used by a pan and tilt head 42 on each broadcast camera 44 for controlling camera lenses 46 for camera movement, zoom and focus; and also (2): process signals from optical encoders attached to the camera heads 42 to transmit pan/tilt position information to the control computer 20.

Also included in the digital interface 40 is at least one receiver 48 that receives the digital control signals from the control computer 20 and converts them to the analog control signals used by the heads and camera lenses for camera movement, zoom and focus. As is known in the art, the pan and tilt head 42 includes motors (not shown) for effecting desired camera movement, and are remotely controllable. Further, the broadcast cameras 44 are provided with mobile supports 50, preferably tripods.

Thus, the control computer 20 is configured for periodically converting the composite target image to PTZF data. Another feature of the control computer 20 is the ability to filter the LiDAR data and the video images from the fixed cameras 34, 36 to focus specifically on the players and the field of play.

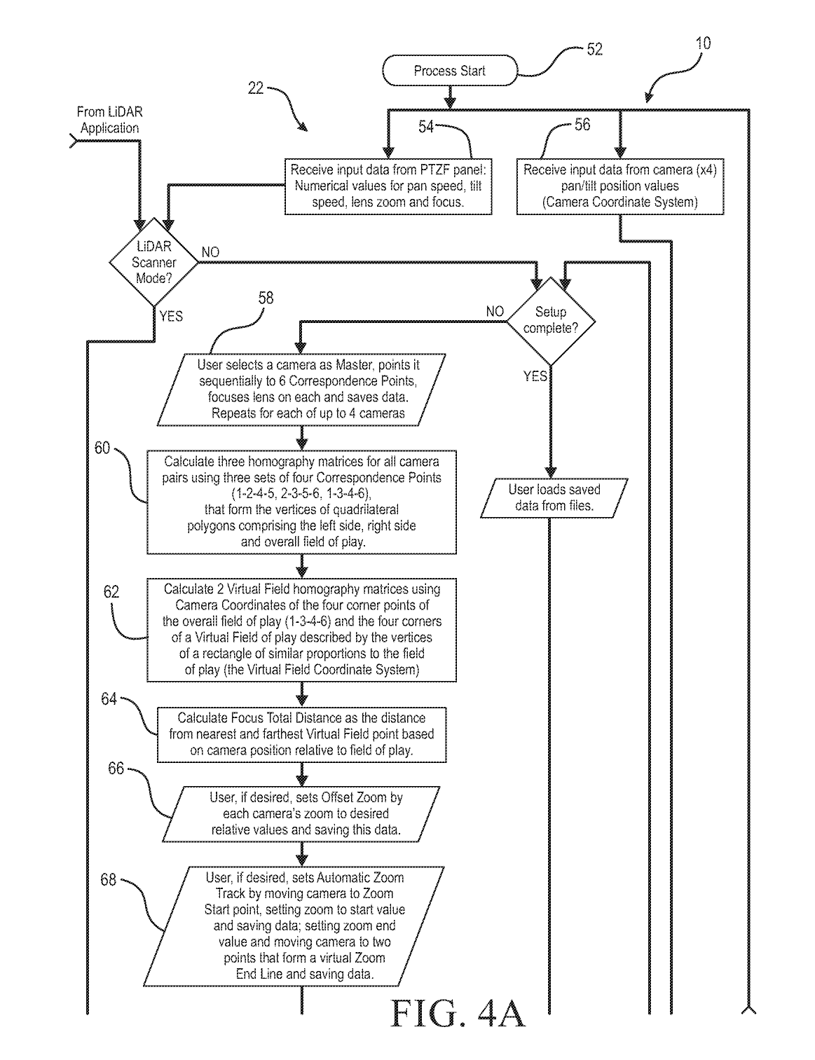

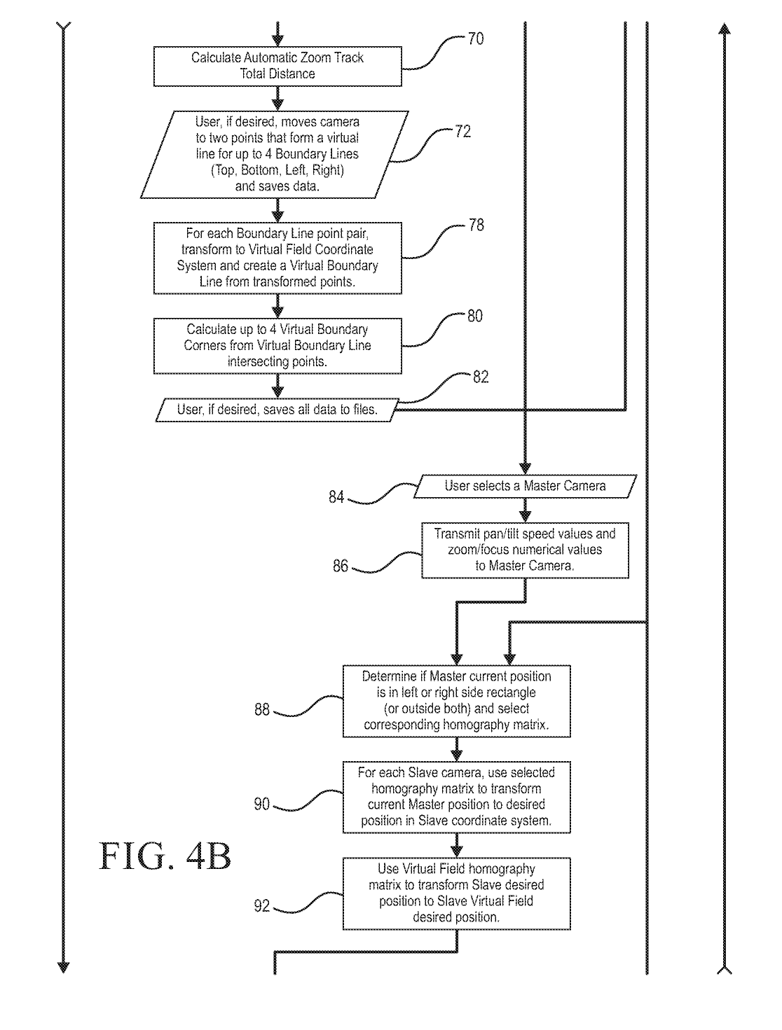

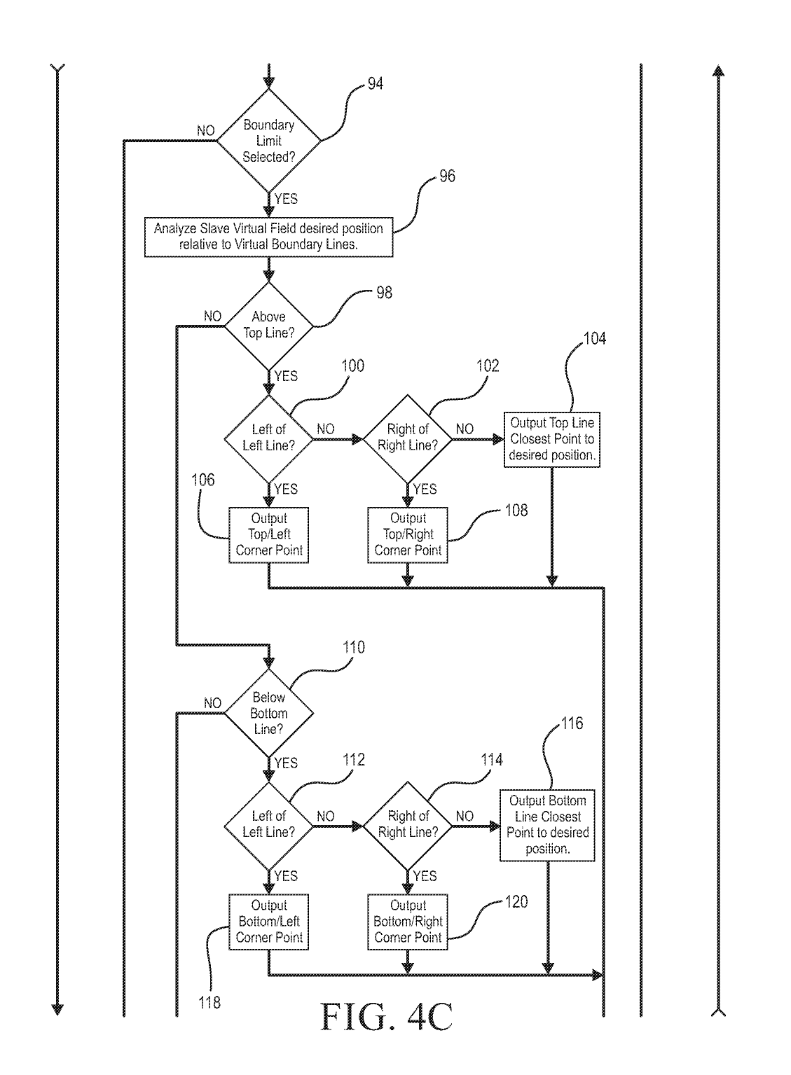

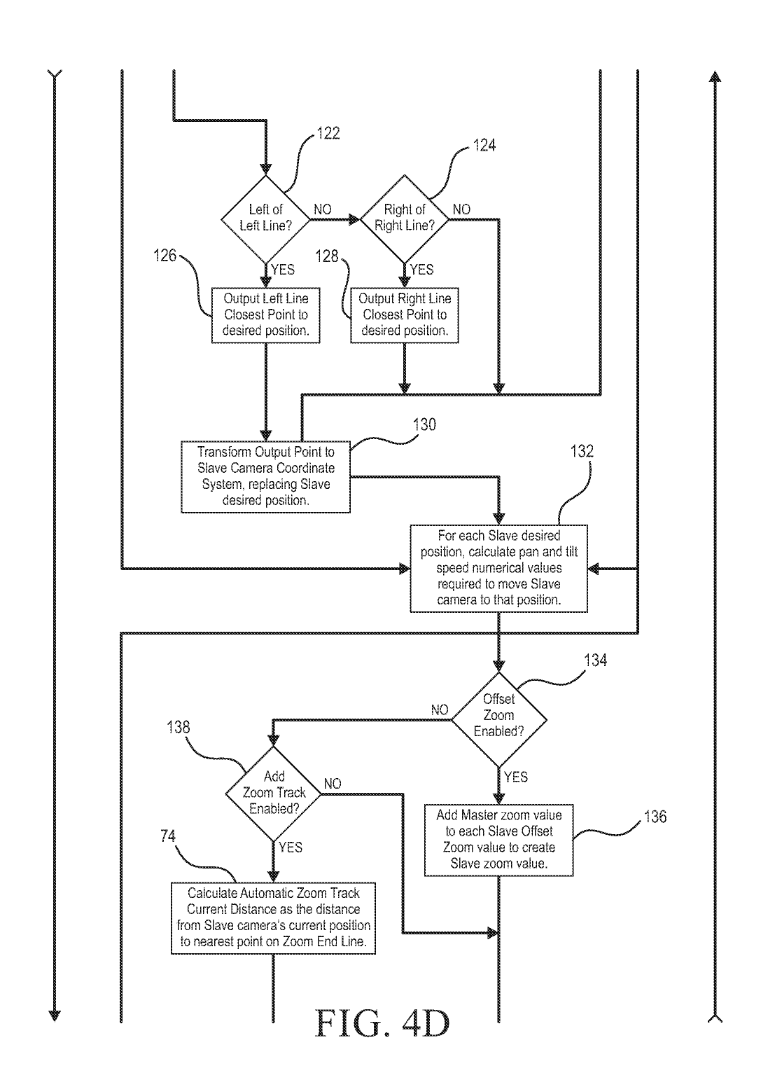

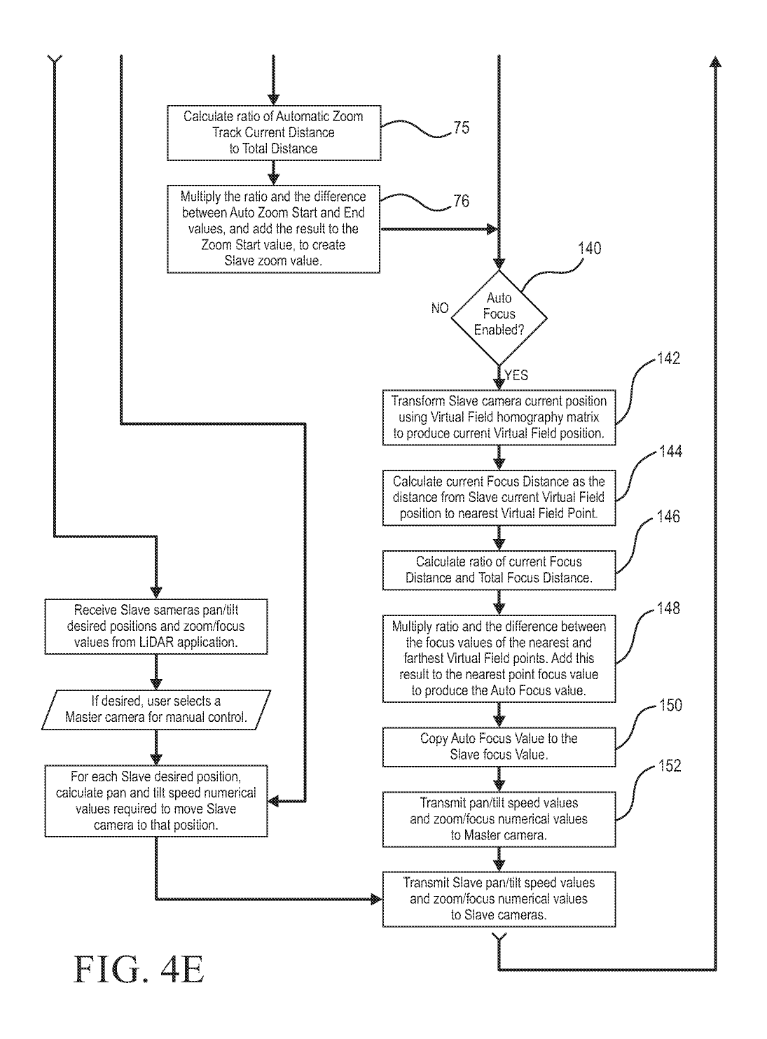

Referring now to FIGS. 4A-E, a fundamental basis of the system 10 is the creation of a Master/Slave control relationship using a plurality of broadcast cameras 44. Thus, the decision tree of FIGS. 4A-E is considered to be a part of the processor 28 in the control computer 20, which is connected to each of the broadcast cameras 44.

In general, the control computer 20 is constructed and arranged so that geographic field, correspondence points, zoom and focus field data is preset for each camera 44, one of the cameras is selected as a Master camera, and the remaining cameras are designated Slaves. The control computer 20 calculates homography matrices for correspondence points and for overall boundaries of the field of play 12. During play, the control computer runs decision loops that repeatedly check the position of the Master and the Slave cameras against the preset homography parameters.

More specifically, upon initiation of the system 10 at 52, up to four broadcast cameras 44 with pan/tilt heads 42 and digital interfaces 40 are positioned above the field of play 12. Prior to the start of the sporting event, the operator takes control of each camera 44 and, using the PTZF panel 24, adjusts the pan/tilt position and lens zoom and focus as seen in steps 54 and 56.

Next, at step 58, the operator selects one of the cameras 44 as a Master, points each camera 44 to six Correspondence Points on the field of play 12, the four corners and two center points on each side, focuses each lens on those points and activates a point save button on the control panel 24. The control computer 20 saves the individual camera pan/tilt coordinates and focus numerical value for each point. At steps 60 and 62, the control computer 20 calculates homography matrices for each camera 44, and the difference in focus values between the nearest and farthest points is calculated. At step 64, using the control computer 20, the user calculates focus total distance as the distance from nearest and farthest virtual field points based on the position of the camera 44 to the field of play 12. At steps 66 and 68, the operator then sets up one of two automatic zoom modes and boundary limits for each Slave camera.

At step 68, the operator sets the zoom for each camera 44 to a desired relative position and touches a button to save each. During operation, as the Master camera's lens 46 is zoomed in or out, each Slave camera's lens will zoom in or out from the relative position to the end of its range.

In FIG. 4B, at step 70, the operator moves a camera 44 to the position at which he/she would like Automatic Zoom Tracking to start, zooms the lens to a desired starting value and touches a button to record that point data. The operator then sets an ending zoom value and points the camera at two other points that form a virtual line, the Zoom End Line.

Referring now to FIG. 4D, a similar calculation process is performed for each of the slave cameras at steps 74-76. For example, the Zoom End Line could be a non-perpendicular line corresponding to the far side of the field 12 from the camera's point-of-view, with the zoom set to provide a good shot of the action there. The operator touches a button to record each point's data. During operation, the controller 24 calculates the Slave cameras' zoom values according to the position of the camera, helping to produce well-composed shots as the action moves from one end of the field to another.

Referring again to FIG. 4B, to ensure that all Slave cameras produce well-composed shots, at steps 78-80, the operator optionally sets up to four Boundary Lines (Top, Bottom, Left and/or Right) that a Slave camera should not cross. This is done by pointing a camera at two points that form a virtual line for a Boundary and saving each. These Boundary Lines can be diagonal if necessary due to the camera's point-of-view relative to the field.

During operation, if a Slave camera is directed to move to the other side of a Boundary Line, it will instead move along the line but not cross it. This allows the operator to specify a custom area that a Slave camera can move within, bounded by one, two, three or four non-perpendicular sides.

To complete setup, at step 82 the operator saves the Correspondence Point, Offset Zoom, Auto Zoom Track and Boundary data to individual files for later recall.

Prior to a broadcast, at step 84 the operator selects the Master camera and at step 86, optionally loads any previously saved Correspondence Point, Offset Zoom, Auto Zoom Track and Boundary data. During a broadcast, the operator selects the Master camera and controls it with the PTZF Panel 24.

Referring now to FIGS. 4B-4D, as the Master camera moves, the control computer 20 receives the camera position coordinates (step 88) and, using a specific homography matrix, transforms the position to the coordinate systems of the other three cameras (the Slave desired position) at step 90. The control computer 20 then, at step 92 calculates the pan/tilt speed numerical values needed to move each Slave to the desired position, and transmits those speed values to each camera's Digital Interface. If Boundary Lines are set (step 94), the Slave camera's desired position is analyzed relative to the Boundary Lines at step 96. Referring now to steps 98-128, if the desired position is on the other side of a Boundary Line (above the Top line, for example), the nearest point on that line is calculated and this point becomes the new Slave desired position at step 130. The Slave cameras will stay within the specified area, moving along the Boundary Lines if necessary but not crossing them. At step 132, the process is repeated for each Slave camera.

If Offset Zoom is enabled at step 134, as the operator zooms the Master camera lens, the control computer 20 calculates the Slave cameras' zoom numerical values and transmits them to each camera's Digital Interface at step 136. Alternately, if Automatic Zoom Tracking is enabled at step 138, the system repeats steps 74-76 and calculates the distance from the camera's current position to the nearest point on the Zoom End Line, adjusts the lens zoom value proportionally and transmits it to the camera's Digital Interface. As the Slave camera moves closer to and further away from the line, the lens is smoothly zoomed in or out between the start and end values.

Referring now to FIG. 4E, at step 140, to adjust the focus of each Slave's lens, the distance from the current position to the nearest and farthest Correspondence Points is calculated at steps 142-150 and compared with the focus values of each, producing a new focus value. This new focus value is transmitted to the Slave camera's Digital Interface. The Slave camera's focus will change as the camera moves, keeping subjects at which the camera is aimed in focus. At step 152, the calculated data is transmitted to the Master camera.

The operator can select any of the four cameras 44 to be a Master at any time during operation. When any camera is selected as Master, its movement is controlled by the PTZF Panel 24 and the other three operate as Slaves.

If at any time the operator wishes to temporarily suspend automatic operation and take control of a specific camera, to obtain a crowd reaction shot or a snapshot for example, he/she touches the Solo Mode button for that camera. All other cameras stop and the selected camera is placed under control of the PTZF panel 24. When finished with the shot, the operator touches the Solo button again and the system returns to automatic operation. The Solo camera returns to its previous position as a Slave and the PTZF Panel control is returned the original Master camera.

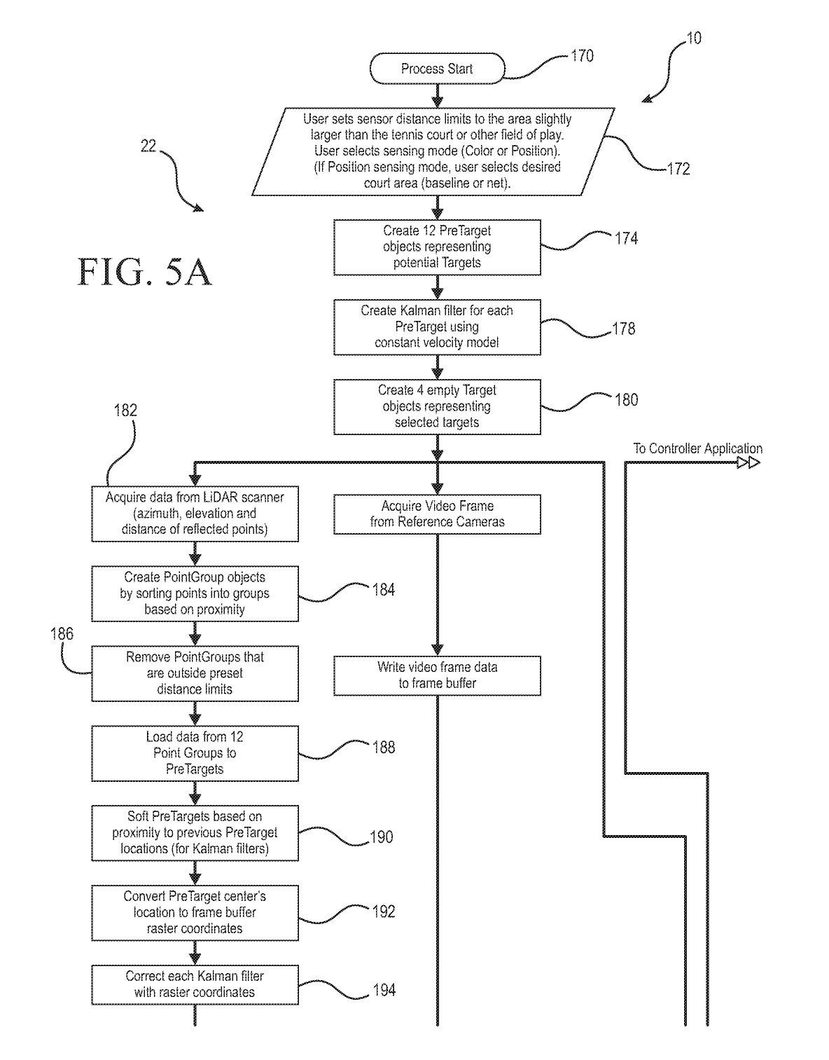

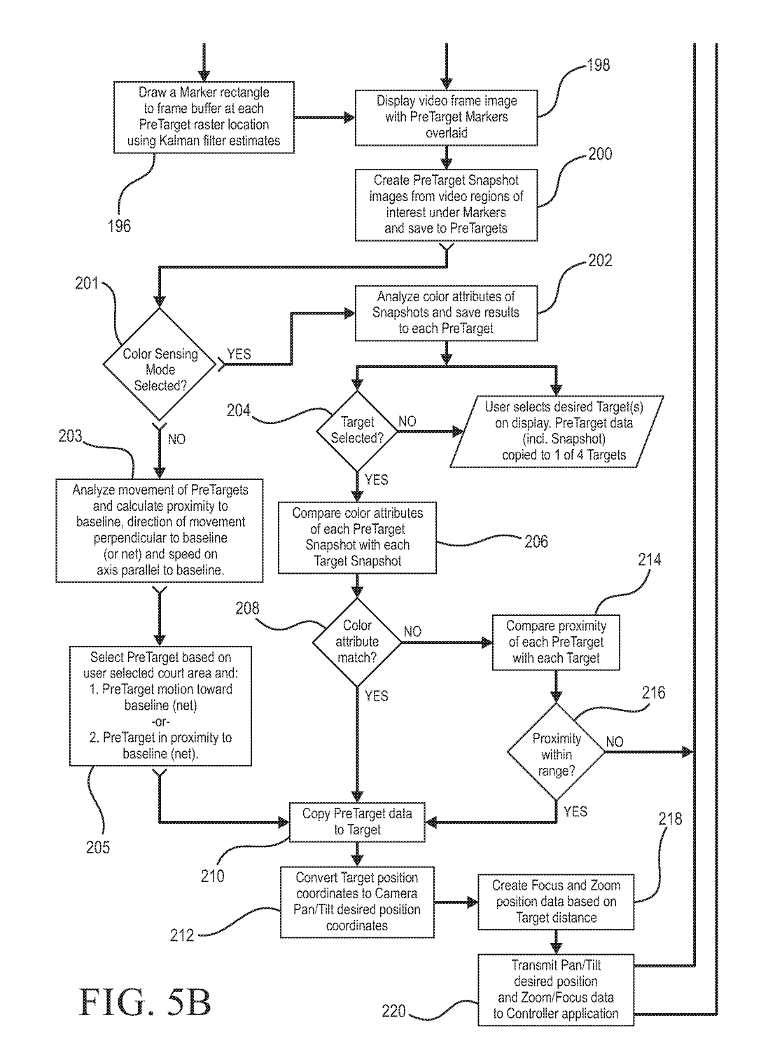

Referring now to FIGS. 5A, 5B and 6, once the Master/Slave portion of the system 10 is set up according to FIGS. 4A-4E, the control computer 20 combines the LiDAR data and the video camera images to discern the players 16, 18 as PreTargets in the surrounding area, limited to the areas of play. As the process begins, at step 170, the user sets at step 172 sensor distance limits just beyond the field of play 12. More specifically, during play, the actual composite Pretarget images are compared with the actual Targets generated by the LiDAR and the video cameras. Periodic snapshots of each Target are stored. Due to the real time operation of the LiDAR scanner 30 and the cameras 44, the control computer 20 is continually examining the images for color, location within the reference geographic zone, and is also converting Target position coordinates to conventional PTZF instructions to be sent to the broadcast camera.

As an optional alternative at this point in the operation, the user selects a sensing mode, which relies on player color or position. If in a position sensing mode, the user then selects a desired playing field location, such as a court area, for example a baseline area or net area in a tennis match. This latter option facilitates differentiation between doubles players in a tennis match, specifically for situations where all players wear the same color. In some cases, player attire is required by the organizers of the particular match.

Since the LiDAR scanner 30 is positioned at a known place relative to the net 14, accurate, real-time data is obtained on the player's positions on the court (FIG. 1). With each new frame of data obtained through the cameras 44, the Pretarget's positions are compared to those of the previous frames for calculating their direction of movement, speed and proximity to the playing field location, such as baseline or the back court line where the players serve the ball. In addition to serving as an alternative when color sensing may be inadequate, this mode has some advantages of its own. The most useful one is that it will automatically select the player who is serving, which is likely to be the one of more interest in between volleys. Also, the opposite can be selected, favoring the player closer to the net. This behavior can be quickly and easily switched by the operator.

The position sensor option 172 operates within the following hierarchy of conditions:

1. Pretargets with fast movement parallel to the baseline are prevented.

2. A Pretarget will be selected if it is near the baseline, or alternately the net for a specific user-settable timeline, for example 2-3 seconds. As an option, the timer can be disabled.

3. If no Pretargets have yet been selected, when the number of Pretargets increase, the one with the highest average movement (such as over 10 frames) toward or away from the baseline or net is selected.

4. If no Pretargets have yet been selected, the one closest or farthest from the baseline is selected.

At step 174, PreTarget images are discerned by analysis of LiDAR data and video camera images detecting groups of reflected laser light points and using these detected groups to produce a Marker 176 on the corresponding video image (FIG. 6). This occurs 20 times per second. Each operation is called a frame. The Markers 176 identify players (and other individuals) within the field of play and are combined with positional and distance data for each. The Markers 176 are also used to produce separate video images (Snapshots) cropped from the main images. At step 178, a Kalman filter is created for each PreTarget using a constant velocity model, and at step 180, additional empty Target objects are created, representing selected targets.

Before play begins, the operator selects up to four of the Markers (two on each side of the court) to become Targets by touching them on the screen. A Snapshot is saved for each Target, and the system begins processing the positional information for each Target.

During play, at steps 182-202, with the LiDAR scanner operating at 20 images or frames per second, with each new frame, the Markers' positions are analyzed relative to the previous frame and the Snapshots' color information is compared with each Target's saved Snapshots. Targets are tracked by using these criteria to assign the correct new Markers' positional information to each Target.

It should be noted that at step 200, depending on how the Target image is sensed, as described above in relation to step 172. After step 200, if a color sensing mode is selected, at 201, the color is analyzed at step 202, and tracking proceeds as the Target moves across the court or field of play.

At step 203, if the color sensing mode is not selected at 201, the system analyzes and the control computer 20 calculates the movement and proximity of the PreTargets relative to the baseline and their direction of movement perpendicular to and/or speed in a direction parallel to a reference point, such as the baseline, net or other playing field marking. Next, at step 205, a particular PreTarget is selected based on the user-selected playing field or court area and either the motion of the PreTarget toward the baseline or net or the proximity of the PreTarget to the baseline or net.

At steps 204-216 the Targets are monitored and updated, and the system 10 produces pan and tilt control signals for the cameras 44 to follow them. Signals from the cameras 44 are available for broadcast as is known in the art, under the control of a Broadcast Director.

The operator can fine-tune the pan and tilt settings to produce well-composed shots for each Target and can also select whether to keep one or both Targets in the shot. At steps 218- 220 the real-time distance information from each Target is processed, producing control signals for automatic zoom and focus, adjusting each as a players' distance from the camera changes. At any time, the operator can select a camera for manual control and, using the PTZF panel, compose specific shots. This flexibility allows one operator to use his skills where they are needed most, such as providing dramatic close-ups of a specific player's face, while the System provides shots of the other players.

While a particular embodiment of the present automatic camera control system for tennis and sports with multiple areas of interest has been described herein, it will be appreciated by those skilled in the art that changes and modifications may be made thereto without departing from the invention in its broader aspects and as set forth in the following claims.

1. A single operator, automatic camera control system for providing action images of at least one player on a field of play, during a sporting event, comprising:
a LiDAR scanner disposed to obtain images from the field of play and constructed and arranged for generating multiple sequential LiDAR images of the at least one player on the field of play;
at least one fixed video camera and disposed to focus on a designated area of the field of play for generating video images that supplement the LiDAR images; and
a control computer connected to said LiDAR scanner and said at least one video camera and configured to combine said LiDAR images and said video images to create a composite target image representative of the at least one player, and to update said composite target image during the sporting event.

2. The automatic camera control system of claim 1, wherein said control computer further is configured for periodically converting said composite target image to PTZF data forming at least a portion of said camera format.

3. The automatic camera control system of claim 1, wherein said control computer is constructed and arranged to receive operator input and selected manipulation of said at least one broadcast camera.

4. The automatic camera control system of claim 1, wherein said control computer is constructed and arranged to store snapshots from said camera format.

5. The automatic camera control system of claim 1, wherein said control computer is constructed and arranged for filtering said LiDAR images and said video images to focus on the players and the field of play.

6. The automatic camera control system of claim 5, wherein said control computer is constructed and arranged for using at least one of player color and player position relative to a designated playing field location for tracking player movement.

7. The automatic camera control system of claim 1, further including a pair of said video cameras, each disposed to focus on a specific region of the field of play.

8. A method of obtaining images of at least one player on a playing field during a sporting event, comprising:
generating, using a LiDAR scanner, LiDAR images from the at least one player on the field of play;
generating, using at least one fixed video camera, reference video images of the at least one player on the field of play corresponding to said LiDAR images; and
combining said LiDAR images and said video to create a composite target image representative of the at least one player, updating said composite target image during the sporting event.

9. The method of claim 8, further including employing a control computer connected to said LiDAR scanner, and to said at least one fixed video camera for receiving said images of the at least one player and tracking the movement of the at least one player by at least one of color and player proximity to, or movement relative to a designated location on the playing field.

10. A multi-camera, single operator Master/Slave camera system, comprising:
a plurality of broadcast cameras;
a control computer connected to each of said cameras;
said control computer is constructed and arranged so that geographic field, Correspondence Points, zoom and focus field data is preset for each camera, one of said cameras is selected as a Master camera, the remaining cameras are designated Slaves, said control computer calculates homography matrices for the Correspondence Points and for the overall field of play boundaries, and during play, said control computer runs decision loops that repeatedly check the position of the Master and the Slave cameras against the preset homography parameters.
